(19) United States
(12) Patent Application Publication
(10) Pub. No.: US 2009/0292373 A1
(43) Pub. Date: Nov. 26, 2009

(54) FIELDBUS COMMUNICATION SYSTEM AND DATA MANAGEMENT APPARATUS

(75) Inventors: Hiroshi Miyata, Musashino-shi (JP); Yukiyo Akisada, Musashino-shi (JP); Masahito Endo, Musashino-shi (JP); Hiroki Endo, Musashino-shi (JP); Kensuke Hosoya, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: Yokogawa Electric Corporation, Tokyo (JP)

(21) Appl. No.: 12/466,000

(22) Filed: May 14, 2009

(30) Foreign Application Priority Data
May 21, 2008 (JP) 2008-132653

(51) Int. Cl. G05B 19/042; G06F 15/16; G06F 13/42

(52) U.S. Cl. 700/1; 709/223; 710/105

(57) ABSTRACT

Disclosed is a fieldbus communication system, comprising: a field device to transmit data; a receiving device to receive the transmitted data; and a data management apparatus which is connectable to a communication system in which the field device and the receiving device are connected to a fieldbus, wherein the receiving device comprises a processing section to perform a transmission request regarding the transmitted data to the data management apparatus, and wherein the data management apparatus comprises: a transmitting/receiving section which is connectable to the fieldbus; a storage section to store the data transmitted from the field device; and a control section to read the stored data corresponding to the transmission request, from the storage section so as to transmit the read data to the receiving device, when the transmission request is received from the receiving device.

### BACKGROUND OF THE INVENTION

1. Field of the Invention

The present invention relates to a fieldbus communication system and a data management apparatus which is connectable to the fieldbus communication system.

2. Description of Related Art

Conventionally, in production factories, large-scale plants, and the like, an instrumentation and control system is known, in which measurement data obtained by various measurement equipments (for example, a sensor such as a thermometer, a flowmeter, and the like) is transmitted to a control device through a network, so that the control device automatically performs a necessary control operation (for example, control processing of a predetermined actuator) to an operation terminal (for example, an actuator such as a motor, an electromagnetic valve, a fan, a pump, a valve, and the like), based on the obtained measurement data.

Further, in recent years, instead of a system using an analog communication method, an instrumentation and control system has been proposed, in which a communication between a measurement device and a control device is performed by using a fieldbus communication method which is a digital bidirectional method (for example, Japanese Patent Application Laid-open Publication No. 11-120031).

In the following description, the instrumentation and control system using the fieldbus communication system is referred to as a fieldbus management system, a measurement equipment and an operation terminal corresponding to the fieldbus communication system is referred to as a publisher, and a control device is referred to as a subscriber.

FIG. 5 is a sequence chart showing a relation ship between a publisher 110 and a subscriber 120 in a conventional fieldbus communication method. A configuration tool 130 is a setting tool to perform a setting pertaining to an association of the publisher 110 with the subscriber 120 (step S101). When the publisher 110 obtains measurement data, the publisher 110 stores the obtained measurement data in a transmission buffer of the publisher 110, so as to transmit the stored measurement data to the subscriber 120 which has been associated with the publisher 110 by the configuration tool 130 beforehand, from the transmission buffer (step S102). When the subscriber 120 succeeds in receiving the stored measurement data in step S102 (step S102: YES), the subscriber 120 stores the measurement data transmitted from the publisher 110 in a reception buffer of the subscriber 120 to perform predetermined processing.

Incidentally, FIG. 5 shows the relationship between the publisher 110 and the subscriber 120 in a state of being one-to-one. However, a transmission of measurement data by a plurality of publishers, and data processing by one or a plurality of subscribers may be performed. There may also be a case in which a single subscriber receives measurement data obtained by an extremely large number of publishers (for example, ten thousands), so as to process the received measurement data.

By the way, the publisher 110 and the subscriber 120 are operated in their respective predetermined schedule. That is to say, the publisher 110 transmits the obtained measurement data to the subscriber 120 in a predetermined period (for example, once per second). Further, the subscriber 120 proceeds with the processing with the assumption that new measurement data is to be received in a predetermined period (for example, once per second). These operations are not synchronized. That is to say, the transmission buffer of the publisher 110 is overwritten to the newest measurement data in a predetermined period by the publisher 110, regardless of the operation of the subscriber 120. Further, the subscriber 120 processes the measurement data stored in the reception buffer in a predetermined period, regardless of the operation of the publisher 110.

On the other hand, during the transmission/reception of data such as measurement data, a failure of the data transmission/reception may possibly occur by a loss of data, and the like, caused by some reason due to the influence of various noises, and the like. Accordingly, in transmitting/receiving the measurement data, for example, when the subscriber 120 fails to receive the measurement data in the above described step S102 (step S102: NO), the measurement data which the subscriber 120 failed to receive is not stored in the reception buffer of the subscriber 120. However, the subscriber 120 is merely operated in the predetermined schedule. Accordingly, the subscriber 120 performs the processing for the data which is already stored in the reception buffer on the occasion, that is to say, the measurement data which has been successful in being received in the previous transmission/reception of the measurement data. Stated another way, the processing which should be performed for the measurement data which should have been received (the measurement data which was unsuccessful in being received) is instead accidentally performed for different measurement data (previously obtained measurement data). Thereby there has been a problem in that the subscriber 120 may perform incorrect processing.

In order to solve the above mentioned problem, the subscriber 120 may request measurement data once again, when the subscriber 120 failed to receive the measurement data. However, the publisher 110 continues to transmit the measurement data in a predetermined schedule, regardless of whether the subscriber 120 is successful in receiving the measurement data, or not. Thus, the transmission buffer of the publisher 110 is constantly overwritten to new measurement data, regardless of the result of the transmission/reception. Accordingly, recovery measures such as transmitting/receiving again the measurement data which was unsuccessful in being received, and the like, are no longer available at all, once the transmission buffer of the publisher 110 has been overwritten. This situation may be improved in some degree by enlarging the capacity of the transmission buffer of the publisher 110. However, it is inefficient to provide each publisher with such a configuration, and this may occur as a problem that the cost of the system increases.

### SUMMARY OF THE INVENTION

An object of the present invention is to provide a fieldbus communication system enabling the recovery of data which a subscriber has failed to receive, without having a publisher perform a generation management of the data, in a system using the fieldbus communication method.

According to an aspect of the present invention, there is provided a fieldbus communication system, comprising:

a field device to transmit data;

a receiving device to receive the transmitted data; and

a data management apparatus which is connectable to a communication system in which the field device and the receiving device are connected to a fieldbus, wherein

the receiving device comprises:

a processing section to perform a transmission request regarding the transmitted data to the data management apparatus, and wherein

the data management apparatus comprises:
a transmitting/receiving section which is connectable to the fieldbus;
a storage section to store the data transmitted from the field device; and
a control section to read the stored data corresponding to the transmission request, from the storage section so as to transmit the read data to the receiving device, when the transmission request is received from the receiving device.

According to another aspect of the present invention, there is provided a data management apparatus which is connectable to a communication system in which a field device to transmit data, and a receiving device to receive the transmitted data are connected to a fieldbus, comprising:

a transmitting/receiving section which is connectable to the fieldbus;

a storage section to store the data transmitted from the field device; and

a control section to read the stored data corresponding to a transmission request regarding the data transmitted from the field device, from the storage section, so as to transmit the read data to the receiving device, when the transmission request is received from the receiving device.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a configuration diagram showing a fieldbus communication system of an embodiment according to the present invention;

FIG. 2 is an explanatory diagram showing a configuration example of entries of set information;

FIG. 3 is an explanatory diagram showing a configuration example of data for each session stored in a control data storage region;

FIG. 4 is a sequence chart showing a flow of the data in the fieldbus communication system; and

FIG. 5 is a sequence chart showing a relationship between a publisher and a subscriber in a conventional fieldbus communication method.

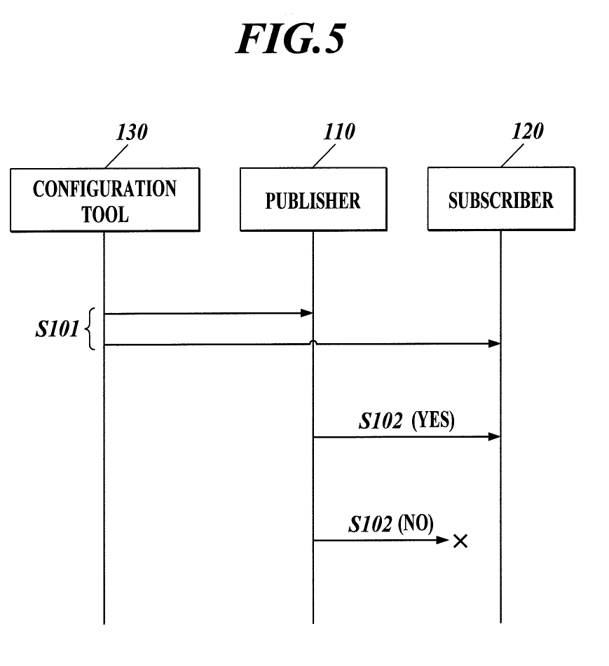

### DETAILED DESCRIPTION OF THE PREFERRED EMBODIMENT

In the following, an embodiment of the present invention is described with reference to the drawings.

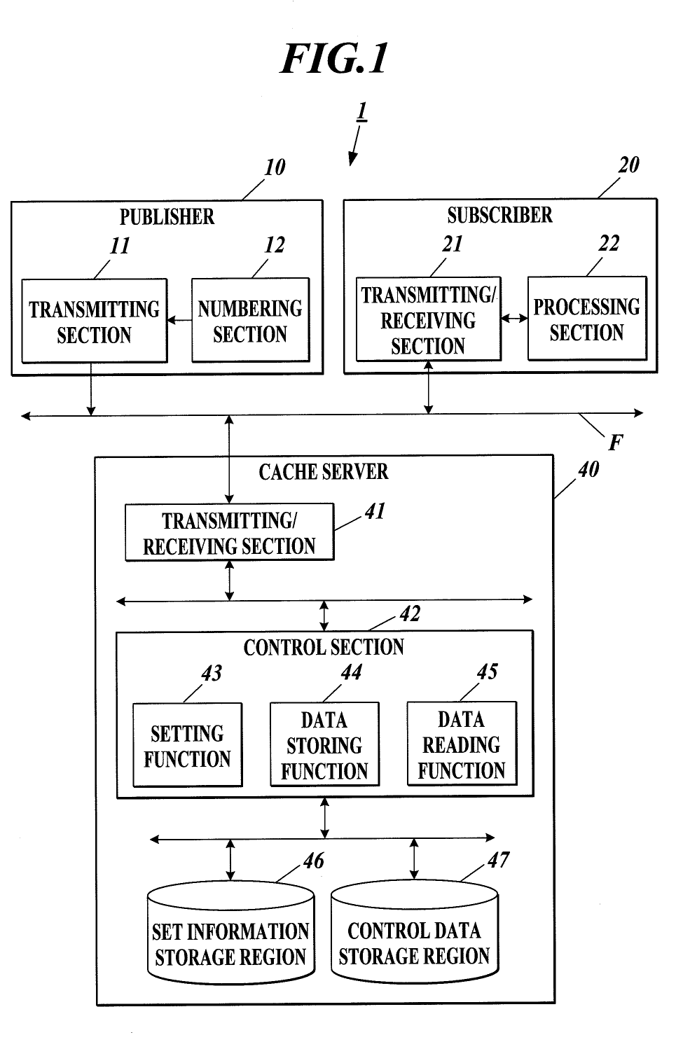

FIG. 1 is a configuration diagram showing a fieldbus communication system 1 of an embodiment according to the present invention. The fieldbus communication system 1 comprises: a publisher 10 to transmit various data (hereinbelow simply referred to as data), such as measurement data, and the like; a subscriber 20 to receive and process the data transmitted from the publisher 10, and to request the transmitted data to a cache server 40 which is described below, when the subscriber 20 failed to receive the transmitted data; a cache server 40 to receive, store, and retain the data transmitted from the publisher 10, and to transmit the stored data corresponding to a transmission request of the subscriber 20; and a fieldbus F to connect each of the devices with each other.

The fieldbus F connects each of the configurations so that the configurations can communicate with each other through a digital communication. A connection by a local area network (LAN) can be named as the configuration of the fieldbus F, and High Speed Ethernet (HSE) (registered trademark) is used in the present embodiment. The lines of the HSE may be configured in a state of being wired/wireless, or a combination thereof. Further, each of the devices connected to the fieldbus F performs the communication by a predetermined communication method. As the communication method, Internet Protocol is used in the present embodiment. Accordingly, each of the devices owns its individual IP address (hereinbelow simply referred to as an address). By the above described configuration, each of the devices of the fieldbus communication system 1 is connected so as to be able to communicate with each other. Incidentally, the fieldbus F may comprise another configuration so that each of the devices is connected so as to be able to communicate with each other through a digital communication.

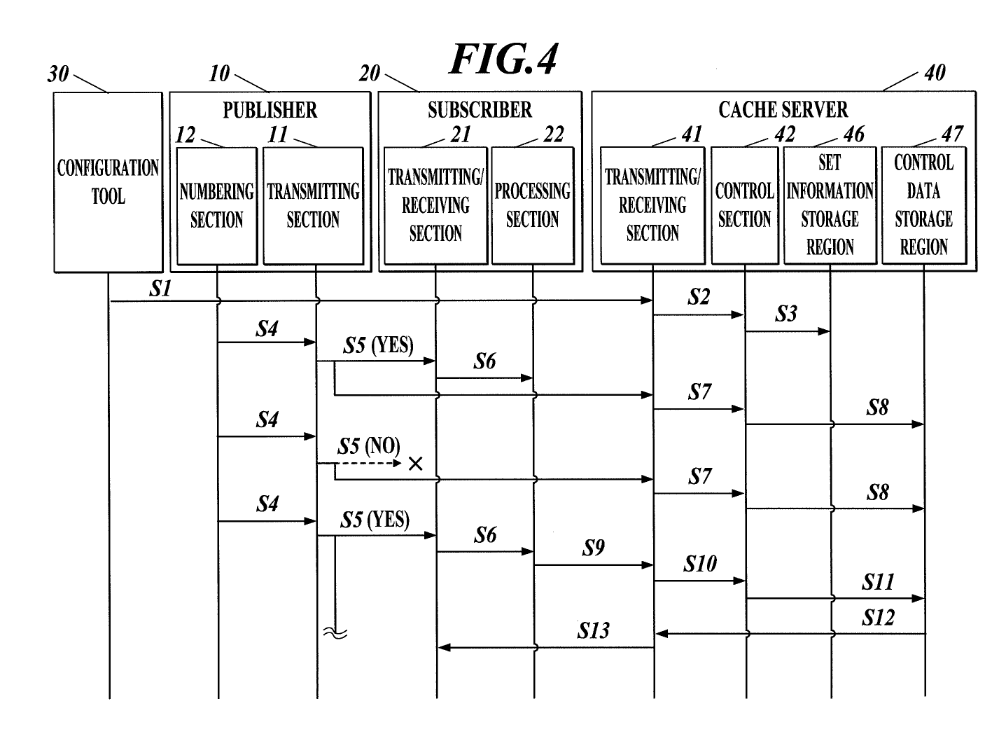

Further, the fieldbus communication system 1 comprises a configuration in which a configuration tool 30 (see FIG. 4) can be executed. The configuration tool 30 associates the publisher 10, the subscriber 20, with the cache server 40. By the association, the data transmitted from the publisher 10 is to be received by the subscriber 20 and by the cache server 40.

To put it concretely, the publisher 10 transmits data with a destination address of multicast. When the transmitted data with the destination address of multicast is reached to the subscriber 20 and the cache server 40, the subscriber 20 and the cache server 40 identify whether the source address of the transmitted data is the address of the associated publisher 10. When the transmitted data is identified to be transmitted from the associated publisher 10, the subscriber 20 and the cache server 40 receive the identified data. When the transmitted data is identified that it is not transmitted from the associated publisher 10, the subscriber 20 and the cache server 40 do not receive the identified data and destroys it.

In the present embodiment, the above described identification accompanied by the data reception is performed by a processing section 22 of the subscriber 20, and by a control section 42 of the cache server 40. However, each of the devices may be provided with a configuration (an identification section) for the identification, alternatively.

The configuration tool 30 can set a port number, a transmission interval of the data which are to be used in the transmission/reception of data, and other various relevant information, other than the information pertaining to the above described association processing. Based on the information (judgment information, e.g. a port number), the subscriber 20 and the cache server 40 can judge what kind the data transmitted from the publisher 10 is. For example, in a case where the publisher 10 transmits a plurality of kinds of data, a different port number may be specified for each kind of data to be transmitted, thereby the subscriber 20 and the cache server 40 can judge the kind of the transmitted data by the specified port number, when receiving the transmitted data. In the present embodiment, the judgment of the data kind based on the port numbers is performed by the processing section 22 of the subscriber 20, and by the control section 42 of the cache server 40. However, each of the devices may be provided with a configuration (a judgment section) for the judgment, alternatively.

The settings of the association and the various information by the configuration tool 30 are performed for each kind of data transmitted from the publisher 10.

The judgment of the data kind may be performed by another method. For example, there may be a method in which the publisher 10 comprises a configuration to add judgment information to the data to be transmitted so that the data kind can be judged, and the subscriber 20 and the cache server 40 judge the data kind based on the judgment information added to the received data, and the like. In this case, different kinds of data can be transmitted in the transmission/reception using the same port numbers.

Incidentally, the example shown in FIG. 1 comprises a single publisher 10, a single subscriber 20, and a single cache server 40. However, at least one of the publisher, the subscriber, and the cache server of the fieldbus communication system may comprise more than one configuration. The configuration tool 30 may associate a plurality of publishers with a single subscriber and/or cache server. The configuration tool 30 may associate a single publisher with a plurality of subscribers and/or cache servers. The configuration tool 30 may further associate a plurality of publishers with a plurality of subscribers and/or cache servers.

Further, other configurations such as another apparatus may be connected to the fieldbus F.

Further, the configuration tool 30 may be provided with an individual apparatus to be connected to the fieldbus F, so as to enable the above described association and the various settings. Alternatively, the publisher 10, the subscriber 20 and/or the cache server 40 may comprise the function.

Next, each device of the fieldbus communication system 1 is described.

The publisher 10 comprises a transmitting section 11 to transmit data; and a numbering section 12 to add a sequence number which indicates a transmission order of the data to be transmitted from the transmitting section 11 as “a transmission order parameter value adding section”. The numbering section 12 adds information which indicates the transmission order, that is to say, the information which enables the reception side (for example, the subscriber 20, cache server 40, and the like) to perform the management of the reception record, to a portion of the data to be transmitted (for example, in the header, or the like). As the information in the present embodiment, the numbering section 12 adds a numeral value which sequentially increases by 1 to the data to be transmitted, each time the data transmission is performed by the transmitting section 11.

The subscriber 20 comprises a transmitting/receiving section 21 which is connectable to the fieldbus F, and a processing section 22 to manage the reception record of the received data and to perform the transmission request so as to request the transmitted data from the cache server 40.

The processing section 22 judges whether the reception of the transmitted data is successful or not, based on the sequence number added to the data transmitted from the publisher 10. To put it concretely, the processing section 22 retains the sequence number of the most recently received transmitted data. Subsequently, when the transmitting/receiving section 21 receives the newest transmitted data, the processing section 22 obtains the sequence number of the newest transmitted data so as to compare it with the retained sequence number of the immediately prior transmitted data.

When the sequence number of the newest transmitted data is increased by 1 from the sequence number of the immediately prior transmitted data, the processing section 22 judges that the reception of the transmitted data is performed according to the transmission order of the transmitted data. In this case, the subscriber 20 performs the processing according to the predetermined schedule.

When the sequence number of the newest transmitted data is not increased by 1 from the sequence number of the immediately prior transmitted data (for example, when the sequence number of the newest transmitted data is increased by 2 or more, and the like), the processing section 22 judges that the reception of the transmitted data is not performed according to the transmission order of the transmitted data. For example, in a case where the sequence number of the immediately prior transmitted data is 1, and the sequence number of the newest transmitted data is 3, the processing section 22 judges that the transmitted data to which the sequence number 2 is added has been unsuccessful in being received. In this case, the processing section 22 performs the transmission request regarding the transmitted data which was unsuccessful in being received, to the cache server 40. Thereby, the processing section 22 performs the reception record management of the transmitted data, and a transmission request regarding the transmitted data which was unsuccessful in being received. The transmission request by the processing section 22 is performed via data communication through the transmitting/receiving section 21.

The reception record management of the transmitted data, and the transmission request regarding the transmitted data by the processing section 22 are realized by a so-called software control, in which a control apparatus (for example, a microprocessor such as a central processing unit (CPU), and the like) performs execution processing of a software corresponding to each content of the processing. Incidentally, the management of the reception record is not limited to the above described method, and may be performed by another method as long as the management of the transmission order of the transmitted data can be performed.

The cache server 40 comprises: a transmitting/receiving section 41 which is connectable to the fieldbus F; a control section 42 to perform various processing according to the reception content of the transmitting/receiving section 41; a set information storage region 46 to store set information pertaining to the association and to the relevant various information obtained by the configuration tool 30, as “an association information storage section”; and a control data storage region 47 to store the data transmitted from the publisher 10, as “a storage section”.

The set information storage region 46 and the control data storage region 47 are a part or an entirety of a storage region of a so-called rewritable storage apparatus (for example, a hard disk, a flash read only memory (ROM), and other apparatus comprising a rewritable storage region). The set information storage region 46 and the control data storage region 47 may respectively be configured by an individual storage apparatus, or by an individual storage region provided in the same storage apparatus.

When the transmitting/receiving section 41 receives various requests, instructions and/or data transmitted from the publisher 10 and the subscriber 20, the transmitting/receiving section 41 sends the received data, and the like, to the control section 42. The reception content by the transmitting/receiving section 41 includes, for example, an instruction pertaining to the settings of the association and the various relevant information obtained by the configuration tool 30; the data transmitted from the publisher 10, the transmission request by the subscriber 20, and the like.

The control section 42 performs the processing according to the content of the various requirements, instructions and/or the transmitted data, and the like, sent from the transmitting/receiving section 41. The control section 42 comprises a setting function 43, a data storing function 44, and a data reading function 45, for the processing. Various functions of the control section 42 are realized by a so-called software control, in which a control apparatus (for example, a microprocessor such as a central processing unit (CPU), and the like) performs execution processing of software so as to operate the functions. In the following, the operation of the control section 42 is described.

When an instruction pertaining to the settings of the association and the various relevant information obtained by the configuration tool 30 is sent from the transmitting/receiving section 41, the control section 42 instructs the setting function 43 to generate set information of the information received from the publisher 10, based on the settings of the association of the publisher 10, the subscriber 20, with the cache server 40, and on the various relevant information obtained by the configuration tool 30. The generated set information is stored in the set information storage region 46 as entries of the set information.

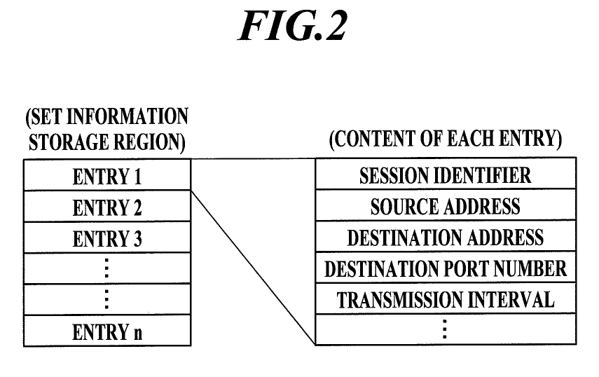

FIG. 2 is an explanatory diagram showing a configuration example of the entries of the set information. An entry of the set information is set for each kind of the data transmitted from the publisher 10. Each entry comprises a session identifier, a source address, a destination address, a destination port number, a transmission interval, other information, and the like. The session identifier is a unique sequence number which is added for each combination of the source address, the destination address, the destination port number, the transmission interval, other information, and the like. The source address is an address of the publisher 10 which transmits the data. The destination address is an address of the subscriber 20 and of the cache server 40 which receive the transmitted data from the source address. The destination port number is a port number which is specified by the transmission side (for example, the publisher 10) at the time of the transmission/reception of the data. The reception side (for example, the subscriber 20) receives the transmitted data which is specified by the port number. The transmission interval is an interval of time at which the data is transmitted. As for the other information, additional information pertaining to the transmission/reception of the data which is set with the session identifier can be set and registered. The information set in the entries can be added, deleted, or changed when necessary.

The cache server 40 receives the transmitted data which corresponds to the above described entry of the set information, among the data transmitted from the publisher 10. The data reception by the subscriber 20 may be performed in the same manner as in the cache server 40.

When the data transmitted from the publisher 10 is sent from the transmitting/receiving section 41, the control section 42 instructs the data storing function 44 to compare a source address, a destination address and a destination port of the data transmitted from the publisher 10 with a source address, a destination address and a destination port of the entries stored in the set information storage region 46 so as to judge which of the entry of the session identifier corresponds to the transmitted data. After the judgment, the data storing function 44 is instructed to store the compared data in the control data storage region 47. On this occasion, the compared data is managed and stored for each of the corresponding session identifier.

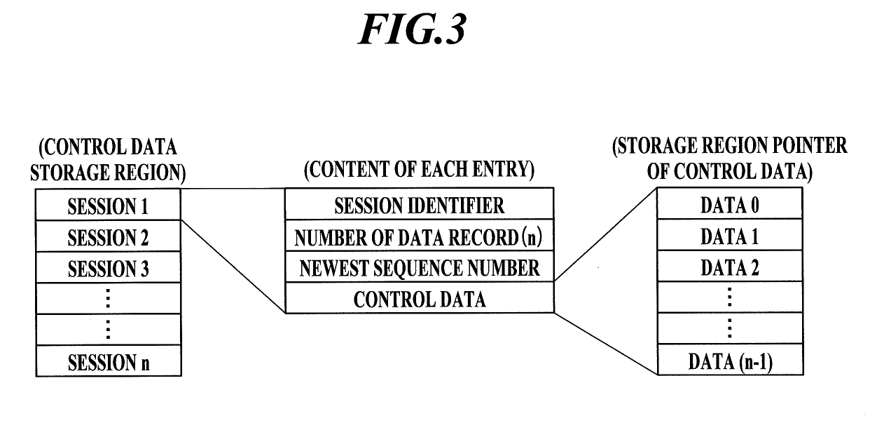

FIG. 3 is an explanatory diagram showing a configuration example of data for each session stored in the control data storage region 47. The data stored in the control data storage region 47 is managed for each session identifier (for example, for sessions 1, 2, 3, . . . , m, and the like). The entry of each session comprises a session identifier, the number of data records, the newest sequence number, and control data.

The session identifier of the entry is identical to the above described session identifier of the set information. The number of data records is a numeral value which indicates the number of data generation which the control data storage region 47 is capable of storing, pertaining to the data corresponding to the session identifier. The newest sequence number is a residue obtained by a result of dividing the sequence number which is added to most recently received data among the sequence numbers indicating the transmission order of the transmitted data corresponding to the session identifier, by the number of data records. That is to say, the newest sequence number is updated each time the cache server 40 receives the data transmitted from the publisher 10.

The control data is an actual data portion obtained by removing sequence numbers and other header information from the data transmitted from the publisher 10. That is to say, the control data is information pertaining to the measurement value which is measured by the publisher 10, a response from the operation terminal, and the like. As shown in FIG. 3, the control data storage region 47 comprises plurality of storage regions of control data for each session.

The number of the storage regions of the control data for each session corresponds to the above described number of data records. For example, as shown in FIG. 3, when the number of data records is “n”, the control data storage region 47 sets the storage regions of control data which are allotted with pointers of 0 to (n−1). Each pointer corresponds to a residue obtained by dividing the sequence number of the received data, by the number of data records. For example, in a case where the residue is 0 as a result of dividing the sequence number of certain received data, by the number of data records, the control data of the certain received data is written in the storage region to which a pointer of 0 is added. On this occasion, the control data is overwritten when another control data has already been written in the storage region. That is to say, the control data storage region 47 stores and retains the control data for the past “n” generations, which is the number of generations set for the number of data records.

When the transmission request by the subscriber 20 is sent from the transmitting/receiving section 41, the control section 42 instructs the data reading function 45 to read the requested data from the control data storage region 47, based on transmission request data from the subscriber 20. The transmission request data comprises the session identifier and the sequence number of the requested data. The control section 42 specifies the requested data based on the session identifier and the sequence number included in the transmission request. To put it concretely, the control section 42 specifies the session of the control data storage region 47 based on the session identifier included in the transmission request. Subsequently, the control section 42 invokes the number of the data records of the specified session, and divides the sequence number of the transmission request data by the number of data records so as to calculate the residue thereof. The data reading function 45 reads the control data stored in the storage region to which the pointer corresponding to the calculated residue is added, as the requested data.

The read data is sent to the transmitting/receiving section 41 and thus transmitted to the subscriber 20.

As described above, the transmission request comprises the session identifiers. Thus, the subscriber 20 and the cache server 40 share the management of the session identifiers. As the method of sharing, the set information of the cache server 40 may be transmitted to the subscriber 20 so as to be shared, or the subscriber 20 may be provided with a configuration similar to the setting function 43 and the set information storage region 46 of the control section 42.

Incidentally, the configuration of the publisher 10 as a measurement equipment or an operation terminal is similar to the conventional ones. The configuration of the subscriber 20 as a control device is also similar to the conventional ones. Accordingly, the descriptions thereof are omitted.

Next, the data flow in the fieldbus communication system 1 is described with reference to the sequence chart shown in FIG. 4. First, the association of the publisher 10, the subscriber 20, with the cache server 40, and various settings are performed by the configuration tool 30 (step S1). The transmitting/receiving section 41 of the cache server 40 sends the instruction pertaining to the association and the various settings performed in step S1 to the control section 42 (step S2). The control section 42 generates the set information pertaining to the information received from the publisher 10 to store the generated set information in the set information storage region 46, based on the instruction sent in step S2 (step S3).

Subsequently, in the publisher 10, the numbering section 12 numbers the transmitted data with the sequence number (step S4), and the transmitting section 11 transmits the numbered data by a multicast method (step S5), according to a predetermined schedule. When the numbered data transmitted in step S5 is received by the transmitting/receiving section 21 of the subscriber 20 (step S5: YES), the transmitting/receiving section 21 sends the received data or the sequence number of the received data to the processing section 22 (step S6). The processing section 22 compares the sequence number of the immediately prior data with the newest sequence number sent in step S6, to judge whether the transmitted data is received according to the transmission order of the publisher 10. On this occasion, when the transmitted data is received according to the transmission order, the subscriber 20 performs the processing according to a predetermined schedule.

In parallel with step S6, when the data transmitted in step S5 is received, the transmitting/receiving section 41 of the cache server 40 sends the received data to the control section 42 (step S7). The control section 42 specifies the session identifier of the received data by referring to the set information stored in the set information storage region 46; divides the sequence number of the received data by the number of data records to calculate the residue thereof as described earlier; and specifies the storage region of the control data which is allotted with the pointer corresponding to the calculated residue. Undergone with such processing, the control section 42 stores the processed data in the control data storage region 47 (step S8).

Here, there is a case where the transmitting/receiving section 21 of the subscriber fails to receive the transmitted data in step S5 (step S5: NO). In this case, the processing in step is not performed. On the other hand, the transmitting/receiving section 41 of the cache server performs the processing in steps S7 and S8 after the transmitted data is received.

When the transmitting/receiving section 21 of the subscriber 20 receives the data transmitted from the publisher 10 after the transmitting/receiving section 21 has failed to receive the previously transmitted data more than once, the processing section 22 judges that the transmitted data is not received according to the transmission order of the publisher 10, because the sequence numbers are not serial. In this case, the processing section 22 performs the transmission request to the cache server 40 to request the transmitted data which was unsuccessful in being received (step S9). The transmitting/receiving section 41 of the cache server 40 sends the transmission request obtained in step S9 to the control section 42 (step S10). The control section 42 reads the requested data from the control data storage region 47 (step S11), to send the requested data read in step S11 to the transmitting/receiving section 41 (step S12). The transmitting/receiving section 41 transmits the read data sent in step S12 to the subscriber 20 (step S13). Thus the processing is terminated.

### [Operational Effect According to the Embodiment]

According to the above described embodiment, the transmitting/receiving section 41 of the cache server 40 receives the data transmitted form the publisher 10, to store the received data in the control data storage region 47. Further, the cache server 40 transmits the requested data to the subscriber 20 based on the transmission request by the subscriber 20 regarding the transmitted data. Accordingly, when the subscriber 20 failed to receive the data transmitted from the publisher 10, the subscriber 20 can perform the recovery operation for the data which was unsuccessful in being received, by performing the transmission request to the cache server 40 regarding the data which was unsuccessful in being received. Thus, a lengthy fieldbus communication system can be established, and the certainty of the data transmission/reception in the fieldbus communication system is significantly improved. That is to say, the data reliability in the processing of the subscriber 20, which is the reliability of the fieldbus communication system, is significantly improved. Further, a processing load for the publisher 10 is not generated in the data recovery operation. Accordingly, each publisher need not be provided with a configuration to perform the data recovery operation, thereby a fieldbus communication system with a low cost and a high reliability can be established.

Further, the data transmitted from the publisher 10 is added with the sequence number. Thus, the subscriber 20 can perform the reception record management as described above. By adding the sequence number to the transmission request data, the processing section of the subscriber 20 can specify the data which is requested from the cache server 40 more concretely. Further, the requested data can be specified by the sequence number. Accordingly, the subscriber 20 can perform the data recovery operation more accurately, and the cache server 40 also can perform an operation according to the data recovery operation of the subscriber 20.

Further, the association of the address of the publisher 10 with the session identifier is performed by the control section 42. Thereby, the subscriber 20 can perform the transmission request in a state of specifying the publisher which is the source of the requested data. The cache server 40 receives the data transmitted from the publisher 10, stores the received data, so as to manage the stored data for each session identifier. In addition, the cache server 40 can judge which of the publisher 10 the transmission request data is directed to. Accordingly, the subscriber 20 can perform the data recovery operation more accurately, and the cache server 40 also can perform an operation according to the data recovery operation of the subscriber 20.

Further, the port number specified by the publisher 10 at the time of data transmission is associated with the session identifier by the control section 42. Thereby, the subscriber 20 can perform the transmission request in which the data kind which is subjected to the request is specified. The cache server 40 receives the data transmitted from the publisher 10, stores the received data, so as to manage the stored data for each data kind. In addition, the cache server 40 can judge which kind of data the transmission request data is directed to. Accordingly, the subscriber 20 can perform the data recovery operation more accurately, and the cache server 40 also can perform an operation according to the data recovery operation of the subscriber 20.

Further, the association of the publisher 10 with the subscriber 20 which receives the data transmitted from the publisher 10, is performed by the control section 42. Thereby, the subscriber 20 and the cache server 40 can restrict the transmitted data to be received among the data transmitted from the publisher 10. Thus, the fieldbus communication system can be established with more flexibility.

For example, in a fieldbus communication system comprising a plurality of publishers 10, and a plurality of subscribers 20 and/or a plurality of cache servers 40, the publisher 10 to perform association for each subscriber 20 and/or cache server 40, is designed to have an individual configuration, thereby the load of the subscriber 20 and the cache server 40 can be reduced.

On the other hand, by associating a single publisher 10 with a plurality of cache servers 40, a further lengthy fieldbus communication system can be established.

Further, the processing section 22 of the subscriber 20 judges whether the reception of the data transmitted from the publisher 10 was successful or not based on the management of the sequence numbers. The subscriber 20 automatically performs the transmission request to the cache server 40 when there was transmitted data which was unsuccessful in being received. That is to say, the subscriber 20 automatically performs the data recovery operation. Thereby, the certainty of the data transmission/reception without a manual operation, which is the reliability of the processing performed by the subscriber 20, can be significantly improved.

Further, the data transmission from the publisher 10 to the subscriber 20 and to the cache server 40 is performed with the destination of the multicast. Thus, the processing load of the publisher 10 is not influenced by whether the numbers of the subscribers 20 and of the cache server 40 are large/small, or increased/decreased. Accordingly, the publisher 10 need not be provided with additional configurations according to the quality or the number of the subscriber 20 and of the cache server 40. Thus, a configuration can be easily added, deleted or changed in the fieldbus communication system.

Incidentally, the whole disclosure of the present embodiment is an example, which does not intend to limit the scope of the present invention. The scope of the present invention is defined not by the above mentioned description but by the appended claims, and is intended to include the equivalent meanings and all variations within the scope of the claims.

For example, the connection method to perform the fieldbus communication is not limited to the Internet Protocol, as long as an inter-communication between each of the devices can be performed. On this occasion, the communication between what is similar to the measurement equipment among the publisher, and the subscriber and the cache server is only required to be able to perform data transmission from the measurement equipment to the subscriber and to the cache server. Further, the communication between what is similar to the operation terminal among the publisher, and the subscriber and the cache server is only required to be able to perform data transmission from the subscriber and the cache server to the operation terminal.

Further, the publisher need not comprise the sequence number adding section. In this case, a management method of the data reception record may be employed, in which whether the data reception is performed periodically is monitored by the subscriber and by the cache server so as to judge whether the transmission/reception of the data is successful or not, for example.

Further, the transmission request data by the subscriber may be transmitted to a destination of a predetermined address, instead of using the session identifiers. For example, the subscriber transmits the transmission request data having a different destination address for each session identifier of the requested data, to a destination of a multicast. When the cache server receives the transmission request having the address, the cache server transmits data having the session identifier corresponding to the address, to the subscriber. In this case, a different cache server for each session identifier may be used, or a single cache server may be able to receive data having a plurality of addresses so as to transmit the data corresponding to the address to the subscriber.

Further, the data transmission from the publisher 10 to the subscriber 20 and to the cache server 40 is performed with the destination of a multicast, and other data transmission is performed with the destination of a unicast in the above described embodiment. However the transmission method is not limited as long as the data transmission/reception from the publisher 10 is performed. For example, when the fieldbus communication system comprises a plurality of cache servers, the subscriber may transmit a transmission request to the plurality of cache servers with the destination of an anycast or of a multicast. In this case, the processing to perform an individual inquiry to each cache server can be omitted, thus result in more efficiency. In addition, the data recovery operation can be completed by transmitting the data requested by any one of the cache servers to the subscriber, thus the reliability of data transmission can be even more improved. Of course, the entire transmissions may be performed with the destination of a unicast.

Further, the transmission request regarding the data stored in the cache server 40 may be performed by a device other than the subscriber 20. As such device, a human machine interface (HMI) equipment, and the like, to perform a management and other processing, pertaining to the fieldbus communication system through a display apparatus by a manager, can be named, for example.

Further, each publisher may comprise a configuration to add a session identifier to the data to be transmitted. In this case, the subscriber 20 and the cache server 40 can be saved from identifying the transmitted data based on the IP address, the port numbers, and the like, thus an integral data management can be performed based on the session identifiers.

According to a first aspect of the preferred embodiments of the present invention, there is provided a fieldbus communication system, comprising:

a field device to transmit data;

a receiving device to receive the transmitted data; and

a data management apparatus which is connectable to a communication system in which the field device and the receiving device are connected to a fieldbus, wherein

the receiving device comprises:
a processing section to perform a transmission request regarding the transmitted data to the data management apparatus, and wherein

the data management apparatus comprises:
a transmitting/receiving section which is connectable to the fieldbus;
a storage section to store the data transmitted from the field device; and
a control section to read the stored data corresponding to the transmission request, from the storage section so as to transmit the read data to the receiving device, when the transmission request is received from the receiving device.

Preferably, according to a second aspect of the present invention, the receiving device automatically performs the transmission request regarding the transmitted data, when the receiving device failed to receive the transmitted data.

Preferably, according to a third aspect of the present invention, the field device comprises a transmission order parameter value adding section to add a parameter value which indicates a transmission order, to the data to be transmitted,

the processing section adds the parameter value which indicates the transmission order of the transmitted data which is requested to transmit to the receiving device, to the transmission request, and

the control section specifies the requested data based on (i) the parameter value which indicates the transmission order obtained from the received data and (ii) the parameter value which indicates the transmission order obtained from the transmission request.

Preferably, according to a fourth aspect of the present invention, the processing section adds identification information of the field device which transmitted the data which is requested to transmit to the receiving device, to the transmission request, and wherein

the control section specifies the requested data based on (i) the identification information obtained from the received data or the identification information obtained based on the received data and (ii) the identification information obtained from the transmission request.

Preferably, according to a fifth aspect of the present invention, the processing section adds judgment information which indicates a kind of the transmitted data which is requested to transmit to the receiving device, to the transmission request, and wherein

the control section specifies the requested data based on (i) the judgment information obtained based on the received data and (ii) the judgment information obtained from the transmission request.

Preferably, according to a sixth aspect of the present invention, at least one of the field device, the receiving device, and the data management apparatus of the fieldbus communication system, is more than one.

Preferably, according to a seventh aspect of the present invention, a data management apparatus which is connectable to a communication system in which a field device to transmit data, and a receiving device to receive the transmitted data are connected to a fieldbus, comprises:

a transmitting/receiving section which is connectable to the fieldbus;

a storage section to store the data transmitted from the field device; and

a control section to read the stored data corresponding to a transmission request regarding the data transmitted from the field device, from the storage section, so as to transmit the read data to the receiving device, when the transmission request is received from the receiving device.

Preferably, according to a eighth aspect of the present invention, the control section specifies the stored data corresponding to the transmission request based on (i) a parameter value which indicates a transmission order obtained from the received data and (ii) a parameter value which indicates the transmission order obtained from the transmission request.

Preferably, according to a ninth aspect of the present invention, the control section specifies the stored data corresponding to the transmission request based on (i) identification information of the field device which transmitted the data, the identification information being obtained from the received data or the identification information being obtained based on the stored data and (ii) the identification information obtained from the transmission request.

Preferably, according to a tenth aspect of the present invention, the control section specifies the stored data corresponding to the transmission request based on (i) judgment information which indicates a kind of the transmitted data, the judgment information being obtained from the received data and (ii) judgment information obtained from the transmission request.

Preferably, according to a eleventh aspect of the present invention, the data management apparatus according to the seventh aspect, further comprises:

an association section to associate the field device with the receiving device; and

an association information storage section to store association information obtained by the association section.

According to an embodiment of the present invention, there is provided a fieldbus communication system enabling the recovery of data which a subscriber has failed to receive, without having a publisher perform a generation management of the data, in a system using the fieldbus communication method.

The entire disclosure of Japanese Patent Application No. 2008-132653 filed on May 21, 2008 including description, claims, drawings, and abstract are incorporated herein by reference in its entirety.

Although an exemplary embodiment has been shown and described, the invention is not limited to the embodiment shown. Therefore, the scope of the invention is intended to be limited solely by the scope of the claims that follow.

What is claimed is:

1. A fieldbus communication system, comprising:
a field device to transmit data;
a receiving device to receive the transmitted data; and
a data management apparatus which is connectable to a communication system in which the field device and the receiving device are connected to a fieldbus, wherein
the receiving device comprises:
a processing section to perform a transmission request regarding the transmitted data to the data management apparatus, and wherein
the data management apparatus comprises:
a transmitting/receiving section which is connectable to the fieldbus;
a storage section to store the data transmitted from the field device; and
a control section to read the stored data corresponding to the transmission request, from the storage section so as to transmit the read data to the receiving device, when the transmission request is received from the receiving device.

2. The fieldbus communication system according to claim 1, wherein the receiving device automatically performs the transmission request regarding the transmitted data, when the receiving device failed to receive the transmitted data.

3. The fieldbus communication system according to claim 1, wherein the field device comprises a transmission order parameter value adding section to add a parameter value which indicates a transmission order, to the data to be transmitted, wherein
the processing section adds the parameter value which indicates the transmission order of the transmitted data which is requested to transmit to the receiving device, to the transmission request, and wherein
the control section specifies the requested data based on (i) the parameter value which indicates the transmission order obtained from the received data and (ii) the parameter value which indicates the transmission order obtained from the transmission request.

4. The fieldbus communication system according to claim 1, wherein the processing section adds identification information of the field device which transmitted the data which is requested to transmit to the receiving device, to the transmission request, and wherein
the control section specifies the requested data based on (i) the identification information obtained from the received data or the identification information obtained based on the received data and (ii) the identification information obtained from the transmission request.

5. The fieldbus communication system according to claim 1, wherein the processing section adds judgment information which indicates a kind of the transmitted data which is requested to transmit to the receiving device, to the transmission request, and wherein
the control section specifies the requested data based on (i) the judgment information obtained based on the received data and (ii) the judgment information obtained from the transmission request.

6. The fieldbus communication system according to claim 1, wherein at least one of the field device, the receiving device, and the data management apparatus of the fieldbus communication system, is more than one.

7. A data management apparatus which is connectable to a communication system in which a field device to transmit data, and a receiving device to receive the transmitted data are connected to a fieldbus, comprising:
a transmitting/receiving section which is connectable to the fieldbus;
a storage section to store the data transmitted from the field device; and
a control section to read the stored data corresponding to a transmission request regarding the data transmitted from the field device, from the storage section, so as to transmit the read data to the receiving device, when the transmission request is received from the receiving device.

8. The data management apparatus according to claim 7, wherein the control section specifies the stored data corresponding to the transmission request based on (i) a parameter value which indicates a transmission order obtained from the received data and (ii) a parameter value which indicates the transmission order obtained from the transmission request.

9. The data management apparatus according to claim 7, wherein the control section specifies the stored data corresponding to the transmission request based on (i) identification information of the field device which transmitted the data, the identification information being obtained from the received data or the identification information being obtained based on the stored data and (ii) the identification information obtained from the transmission request.

10. The data management apparatus according to claim 7, wherein the control section specifies the stored data corresponding to the transmission request based on (i) judgment information which indicates a kind of the transmitted data, the judgment information being obtained from the received data and (ii) judgment information obtained from the transmission request.

11. The data management apparatus according to claim 7, further comprising:
an association section to associate the field device with the receiving device; and
an association information storage section to store association information obtained by the association section.
